(19) United States
(12) Patent Application Publication
(10) Pub. No.: US 2016/0012752 A1
(43) Pub. Date: Jan. 14, 2016

(54) RESUSCITATION SIMULATOR WITH COMPRESSION MEASUREMENT

(71) Applicant: 3B Scientific GmbH, Hamburg (DE)

(72) Inventor: Heiko Maleska-Kubick, Hamburg (DE)

(21) Appl. No.: 14/693,221

(22) Filed: Apr. 22, 2015

(30) Foreign Application Priority Data
May 9, 2014 (DE) 202014102161.2

(51) Int. Cl. G09B 23/28

(52) U.S. Cl. CPC G09B 23/288

(57) ABSTRACT

A resuscitation simulator includes a chest wall which moves back and forth along a compression path and a distance sensor as described for the invention which measures the optical path length between a transmitter and a receiver. The optical path length is determined by the position of the chest wall along the compression path. This enables the simple determination of the compression depth during reanimation training by measuring the optical path length and furnishes feedback to the person undergoing training in respect of the quality of the cardiac massages performed.

### CROSS-REFERENCE TO RELATED APPLICATIONS

The present application claims priority under 35 U.S.C. 119 to German utility model patent application DE 20 2014 102 161 U1, filed on May 9, 2014, which is relied upon and incorporated herein in its entirety by reference.

### FIELD OF INVENTION

The invention concerns a resuscitation simulator according to the generic character.

### BACKGROUND OF THE INVENTION

Resuscitation simulators in the form of human dummies for training cardiac resuscitation are well known. Resuscitation simulators serve to train reanimation techniques, in particular those utilizing cardiac massage in combination with artificial respiration.

The correct performance of a cardiac massage, i.e. enhancing the probability of the patient's survival, requires considerable training, particularly in respect of the thoracic compression depth. In order to train the correct compression depth, until now the required feedback regarding the compression depth was entirely the responsibility of the person conducting the schooling.

However, the information about the compression depths of the cardiac massages performed which present-day resuscitation simulators furnish is insufficient.

### BRIEF SUMMARY OF THE INVENTION

It is therefore the purpose of the present invention to improve the resuscitation simulator described at the outset by being able to determine the compression depth more exactly.

The resuscitation simulator described herein fulfills this purpose.

The resuscitation simulator described has a chest wall which undergoes movement back and forth along a compression path and a distance sensor as described for the invention which measures the optical path length between a transmitter and a receiver. The optical path length is determined at least in part, and preferably entirely, by the position of the chest wall along the compression path.

This enables the simple determination of the compression depth during reanimation training by measuring the optical path length and furnishes feedback to the person undergoing training in respect of the quality of the cardiac massages performed.

Preferably, the transmitter emits radiation, the intensity of which diminishes with increasing path length. The receiver measures the incoming radiation intensity. From this measurement the optical path length, and therefore the compression depth, can be calculated.

The transmitter is ideally an IR LED and/or the receiver also an IR LED. The use of radiative transmitters, in particular in the form of IR LEDs, enables the cost-effective integration of a distance sensor. This is essentially based upon the change in the optical path length of the IR radiation between the two IR LEDs, which in turn changes the measured intensity at the IR LED receiver, provided that the IR LED transmitter emits a constant radiation intensity.

In a particularly preferred design of the resuscitation simulator the transmitter alternates between a switched-on and a switched-off state. In the switched-on state the transmitter generates radiation of constant intensity, and in the switched-off state the transmitter generates no radiation. In the switched-off state of the transmitter the receiver measures spurious radiation and converts this to a noise measurement signal which can be processed and temporarily stored in a microprocessor memory as required. In the switched-on state of the transmitter the receiver ideally measures the total radiation and converts this to a total measurement signal, which can be pre-processed and sent to the microprocessor. The microprocessor incorporates an algorithm according to which the actual useful measurement signal can be derived from the total measurement signal and the previously stored noise signal. This signal is then available for further pre-processing and evaluation.

The useful measurement signal serves as the basis for the calculation of the optical path length traversed by the radiation and therefore for the calculation of the compression depth of the chest wall which the person training produces.

Preferably, the distance sensor is comprised of a mushroom pushbutton switch which moves back and forth along the compression path, with the position of the outside fixed to the chest wall and the inside having a reflection plane, situated opposite the transmitter and the receiver. The optical path length is determined by the distance between the transmitter and reflection plane and between the reflection plane and receiver. This allows the simple mechanical construction of the distance sensor.

In a particularly preferred design of the invention the transmitter is comprised of an IR LED connected by an electrical conducting path to a collector of a transistor in the common emitter state, while the base current of the transistor can be switched on and off. The operating point of the transistor can be set in the known manner via three fixed resistances. A voltage divider provided at the base of the transistor is preferably driven from a constant voltage source which can be switched on and off. Switching the voltage source on and off essentially generates a square wave signal through the IR LED which the receiver picks up.

Ideally, the receiver comprises an IR LED, connected to a constant voltage source and in series with a measuring shunt, and a measurement signal tap for obtaining a measurement signal. By receiving IR light, the IR LED generates a leakage current. The leakage current arises due to a weak photovoltaic effect produced by the IR radiation impinging upon the receiver. The voltage drop produced by the leakage current at the measuring shunt is available to a signal pre-processing circuit.

In a particularly preferred design the signal pre-processing circuit comprises an amplifier circuit, ideally in the form of a non-inverting first operational amplifier which amplifies the measurement signal from the receiver and is connected to the first input of a summer. Ideally, a second operational amplifier is connected as the summer. The summer subtracts a reference voltage from the amplified measurement signal. As a result of amplification, the fluctuations of the measurement signal are in a voltage range in which a normal microprocessor is not controlled. The voltage must therefore be shifted to a suitable range. Ideally, this shift of the voltage range is achieved with an offset compensation circuit acting together with the signal pre-processing circuit. The offset compensation circuit generates the reference voltage supplied to the summer together with the amplified measurement signal.

The offset compensation circuit ideally has a third operational amplifier connected as a voltage follower. The voltage follower provides a loadable intermediate reference voltage without amplification. The intermediate reference voltage is supplied to a fourth operational amplifier connected as a non-inverting amplifier, and the intermediate reference voltage is amplified to the required reference voltage. The output of the fourth operational amplifier is connected to the second input of the second operational amplifier functioning as a summer. The variable pre-processed measurement signal at the output of the summer is then in a voltage range which the microprocessor can evaluate.

### BRIEF DESCRIPTION OF THE SEVERAL VIEWS OF THE DRAWINGS

The invention is described with the help of a design example, in six figures.

FIG. 1a shows a schematic sectional view of the resuscitation simulator in accordance with the invention described.

FIG. 1b shows a perspective view of the compression module in FIG. 1.

FIG. 2 shows the IR transmitter circuitry.

FIG. 3 shows the IR receiver circuitry.

FIG. 4a shows the signal pre-processing circuitry of the amplifier circuit for the measurement signal from the IR sensor.

FIG. 4b shows the offset compensation circuitry of the amplifier circuit.

### DETAILED DESCRIPTION OF THE INVENTION

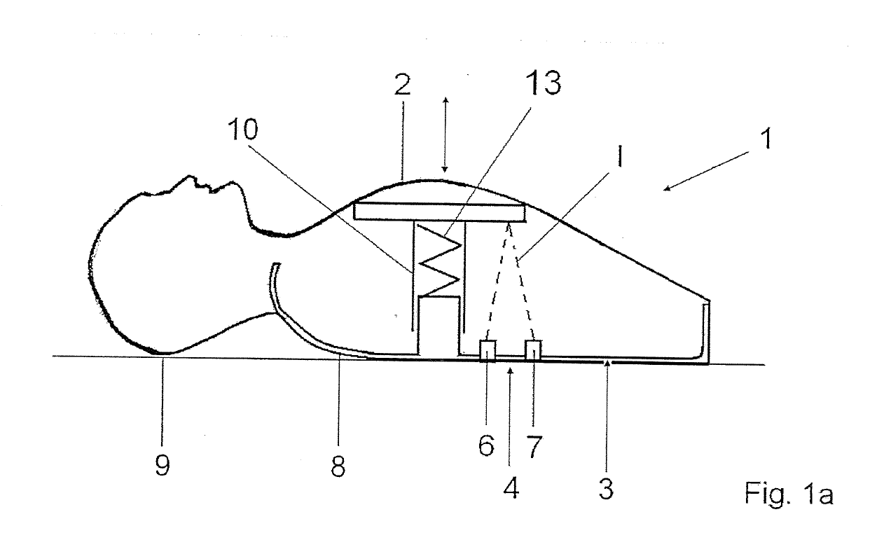

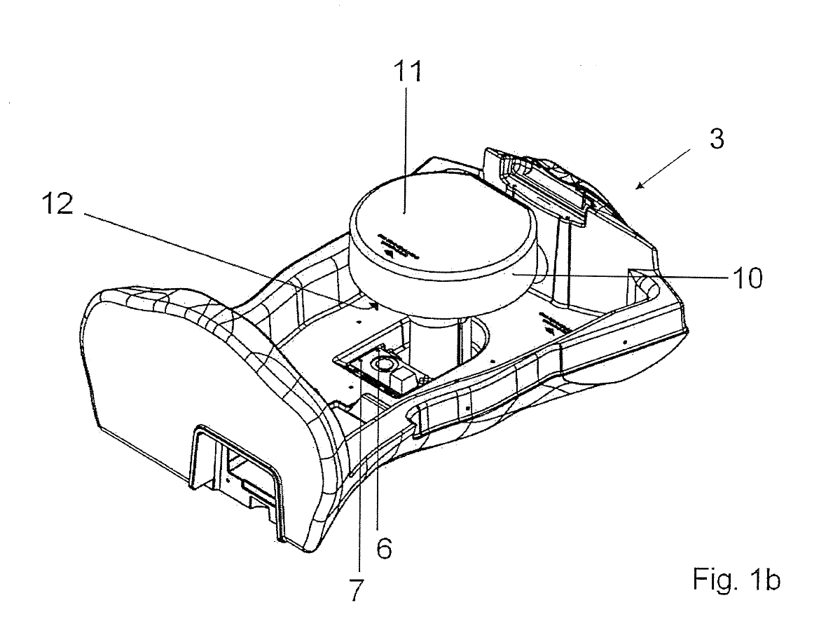

In accordance with the resuscitation guidelines of the European Resuscitation Councils (ERC), for the basic measures of the general procedure for the resuscitation of a patient a ratio of 30 cardiac massages to two artificial respiration phases is recommended. The resuscitation simulator 1 described here includes a built-in compression module 3 for training the cardiac massages. The compression module 3 is also illustrated in FIG. 1b. Further modular components are also included with the resuscitation simulator 1, which in the interest of simplicity are not shown here and which are concerned, for example, with insufflation. The figures are not true to scale.

FIG. 1a shows the resuscitation simulator 1 described, in the form of a human. The resuscitation simulator 1 has a chest wall 2 which moves back and forth along the compression path indicated by a double arrow. The resuscitation simulator 1 is suited for training cardiac massages.

The chest wall 2 can be compressed along the displacement path by overcoming a counteracting spring 13 force. The counterforce corresponds roughly to the counterforce of an average adult thorax which must be overcome during cardiac massage.

The ERC guidelines mentioned above recommend a maximum compression depth of 6 cm. However, compression depths less than 4 cm are also not recommended. Consequently, a compression depth of 4 to 6 cm is advisable for an adult person in order to achieve the maximum resuscitation probability.

The resuscitation simulator 1 described serves to train the compression depth by means of a distance sensor 4, comprising an IR LED 2 transmitter 6 and an IR LED 1 receiver 7, which optimally measures the length of the IR radiation path between the IR transmitter 6 and the IR receiver 7 on the basis of one of the optical IR radiation paths.

The resuscitation simulator 1 is shown in FIG. 1a with the rear face 8 of the compression module 3 lying flat on a permanent base 9. The helper presses with the flat hand on the outside of the chest wall 2 in the direction of the fixed base by pushing the mushroom pushbutton switch 10 of the compression module 3 against the spring 13. The chest wall 2 is elastic in order to be able to move with the compression movement.

FIG. 1b shows the function of the compression module 3. The inside of the chest wall 2 lies on the pressure-resistant outside 11 of the mushroom pushbutton switch 10. The mushroom pushbutton switch 10 is painted white on the inner side, facing the IR transmitter 6 and the IR receiver 7, and thus forms a reflection plane 12 for IR radiation. The mushroom pushbutton switch has a hollow shaft. The spring 13 which generates the counterforce for the helper's compression movement is located in the shaft.

The reflection plane 12 reflects the IR beam from the IR transmitter 6 and deflects the beam to the IR receiver 7. As a result of the compression movement the mushroom pushbutton switch 10 moves up and down along the compression path. The optical path length l between the IR transmitter 6 and the IR receiver 7 changes according to the position of the reflection plane 12 along the compression path. The IR transmitter 6 emits an infrared signal, the intensity of which changes inversely with the square of the distance from the IR transmitter 6. The IR receiver 7 picks up the signal and generates a measurement signal in the IR receiver 7, the intensity of which is a function of the IR radiation received.

As a rule, the IR radiation impinging upon the IR receiver 7 includes noise components, such as daylight or—in particular—emission from fluorescent lamps, which also emit radiation in the IR range. In order to enable an exact measurement of the optical path length l between the IR transmitter 6 and the IR receiver 7 it is necessary to correct the signal measures at the IR receiver 7 for the noise sources.

For this purpose the IR transmitter 6 is switched on after 20 ms and after a further 20 ms switched off again, while the IR receiver 7 continuously measures the IR radiation. The IR radiation received generates a total measurement signal which, with the IR transmitter 6 switched on, is comprised of a noise measurement signal superimposed over the useful signal and, with the IR transmitter 6 switched off, only the measured noise signal is measured at the IR receiver 7. The useful measurement signal employed is essentially determined as the difference of the total measured signal and the measured noise signal

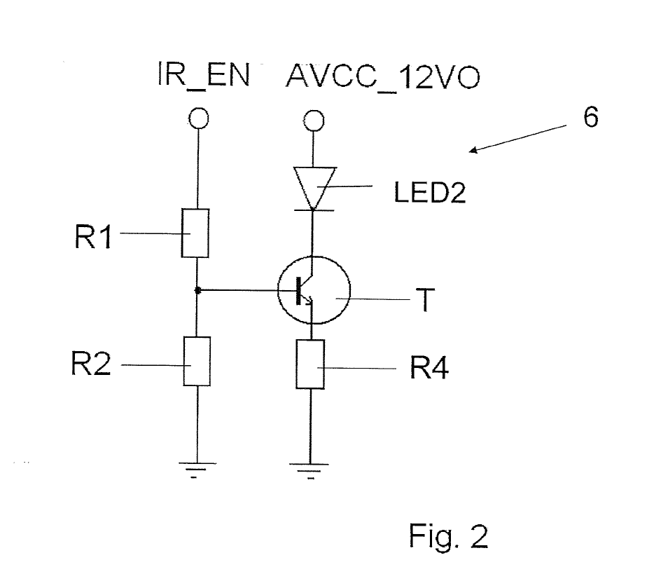

FIG. 2 is a schematic illustration of the IR transmitter 6. The IR LED 2 is connected to the collector of a transistor T operating in common emitter mode. The operating point of the transistor T is set from three fixed resistances R1, R2, R4. The base of the transistor T is connected via one of the two resistances R1, R2 to a current source IR_EN which can be switched on and off. The current through the voltage divider R1, R2 is switched on after 20 ms and switched off again after a further 20 ms. As a result the IR LED 2 generates a roughly square wave radiation profile.

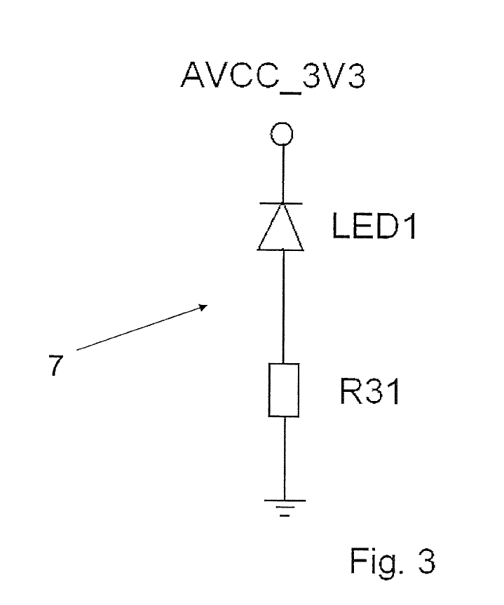

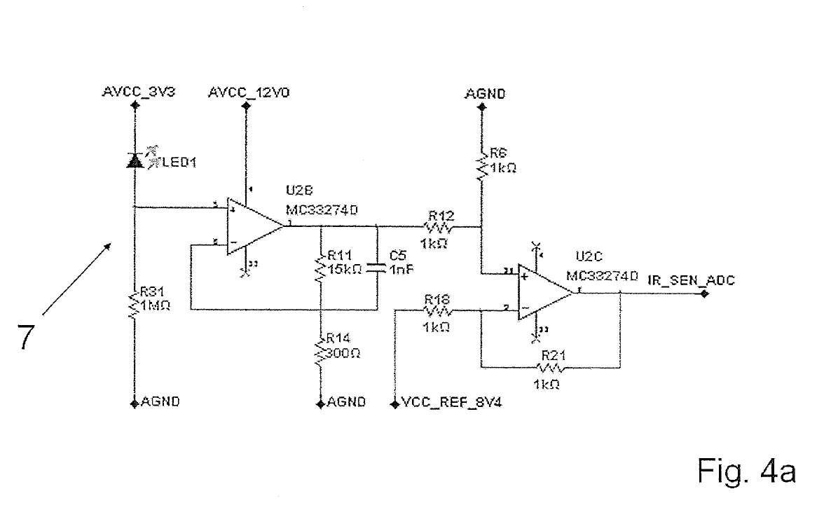

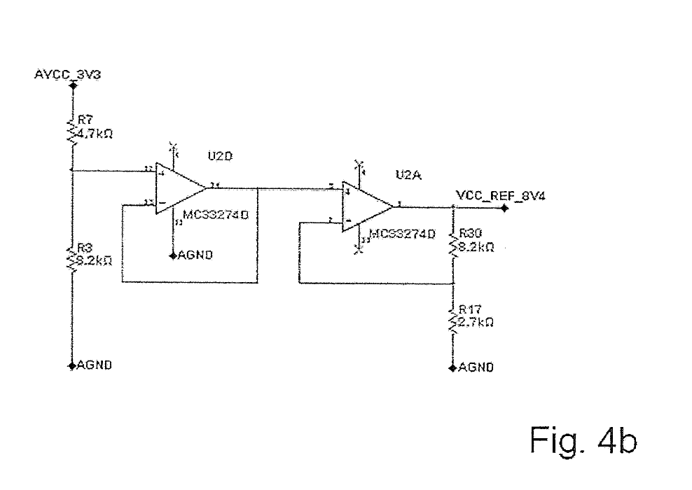

FIG. 3 shows the circuitry for the IR receiver 7, comprising the IR LED 1. The IR LED 1 is in series with a 1 MΩ measuring shunt R31. As a result of receiving infrared radiation, the IR LED 1 generates a photocurrent in the IR receiver 7. The voltage drop across the measuring shunt 31 is pre-processed in the amplifier circuitry as shown in FIG. 4a and FIG. 4b and is available at the output IR_SEN_ADC.

FIGS. 4a and 4b must be read together. Together they represent the amplifier circuit, comprised of the signal pre-processing circuitry shown in FIG. 4a, as is seen in the left part of the circuit, which measures and pre-processes the measuring shunt R31. Pre-processing takes place by a non-inverting first operational amplifier U2B, shown here with an amplification factor of V_{U}=1+(R11/R14)=50. The amplified signal is then sent via a resistance R12 to a second operational amplifier U2C which functions as a summer.

In FIG. 4a and FIG. 4b the terminals to be connected are marked in the same manner. In particular, the output of a fourth operational amplifier U2A is connected via a resistance R18 to the negative input of the second operational amplifier U2C.

The offset compensation circuit of FIG. 4b serves to shift the signal available at the output IR_SEN_ADC to a voltage range from 0 to 3.3 Volts, as this is the operating range of the microprocessor connected to the IR_SEN_ADC. The offset compensation circuit has a third operational amplifier U2D and the fourth operational amplifier U2A, with the third operational amplifier U2D functioning as a voltage follower which generates a reference voltage URef 1=UVCC×(R3/(R3+R7))=2.1 Volts when the voltage UVCC on the voltage divider R3, R7=3.3 Volts, as shown in FIG. 4b. The voltage follower provides the non-amplified reference voltage of 2.1 Volts to the positive input of the fourth operational U2A. The fourth operational amplifier U2A is operated as a non-inverting amplifier with the amplification factor V_{U}=1+(R30/R17)=4. The third operational amplifier U2D and fourth operational amplifier U2A together therefore generate a reference voltage of VCC_REF=8.4 Volts. This voltage corresponds exactly to the required offset compensation voltage. The reference voltage VCC_REF is sent to the second operational amplifier U2C, functioning as a sum amplifier with amplification V_{U}=1, and extracts the reference voltage of 8.4 Volts from the amplified sensor signal. In this way a pre-processed measurement signal is developed in the voltage range from 0 to 3.3 Volts. This pre-processed sensor signal IR_SEN_ADC is first digitized by the analog-digital converter and then sent to the microprocessor (not shown) for further processing.

Although the invention herein has been described with reference to particular embodiments, it is to be understood that these embodiments are merely illustrative of the principals and applications of the present invention. Accordingly, while the invention has been described with reference to the structures and processes disclosed, it is not confined to the details set forth, but is intended to cover such modifications or changes as may fall within the scope of the following claims.

### FIGURE REFERENCES

1 Resuscitation simulator
2 Chest wall
3 Compression module
4 Distance sensor
6 IR transmitter
7 IR receiver
8 Rear face of the compression module
9 Fixed base
10 Mushroom pushbutton switch
11 Outside of the mushroom pushbutton switch
12 Reflection plane
13 Spring
l Optical path

What is claimed is:

1. A resuscitation simulator comprising:
a chest wall (2) which moves back and forth along a compression path; and
a distance sensor (4) with a transmitter (6) and a receiver (7) which measures the optical path length (l) according to the position of the chest wall (2) along the compression path.

2. A resuscitation simulator as described in claim 1, wherein the transmitter (6) emits radiation, the intensity of which diminishes with increasing optical path length (l) and in which the receiver (7) measures the intensity of the radiation impinging upon it.

3. A resuscitation simulator as described in claim 1, wherein the transmitter (6) comprises an IR LED.

4. A resuscitation simulator as described in claim 1, wherein the receiver (7) comprises an IR LED.

5. A resuscitation simulator as described in claim 1, wherein the transmitter (6) and the receiver (7) are configured relatively rigidly in relation to each other and relatively rigidly in relation to the chest wall, with the optical path length (l) of the radiation from the transmitter (6) running via the reflection plane (12) permanently fixed to the chest wall (2) to the receiver (7).

6. A resuscitation simulator as described in one of the above claim 1, wherein the transmitter (6) alternates between a switched-on state and a switched-off state, with the receiver (7) measuring spurious radiation in the switched-off state of the transmitter (6) and converting this to a noise measurement signal, and a microprocessor memory provided for the noise measurement signal.

7. A resuscitation simulator as described in claim 6, wherein the receiver (7) in the switched-on state of the transmitter (6) measuring the total radiation and converting this to a total measurement signal for the microprocessor.

8. A resuscitation simulator as described in claim 6, further comprising an algorithm in the microprocessor which eliminates the noise signal component of the total measurement signal and determines the useful measurement signal.

9. A resuscitation simulator as described in one claim 1, wherein the distance sensor (4) comprises a mushroom pushbutton switch (10) with the outside (11) permanently fixed to the chest wall (2) and the inside having a reflection plane (12), with the reflection plane (12) situated opposite the transmitter (6) and the receiver (7), which moves back and forth along the compression path and in which the optical path length (l) is determined according to the distance between the transmitter (6) and reflection plane (12) and between the reflection plane (12) and the receiver (7).

10. A resuscitation simulator as described in claim 1, wherein the transmitter (6) comprises an IR LED connected by an electrical conducting path to a collector of a transistor (T) in the common emitter state, while the base current of the transistor (T) can be switched on and off.

11. A resuscitation simulator as described in claim 1, wherein the receiver (7) comprises an IR-LED connected to a constant voltage source and in series with a measuring shunt (R13), and a measurement signal tap for obtaining a measurement signal from the IR LED.

12. A resuscitation simulator as described in claim 1, further comprising a signal pre-processing circuit which amplifies the signal measured by the receiver (7) and is connected to the first input of a summer (UVC) and provided with an offset compensation circuit which generates a reference voltage (VCC REF) and is connected to the second input of a summer (UVC) and in which the summer extracts the reference voltage (VCC REF) from the amplified measurement signal and allocates this pre-processed measurement signal to a pre-defined voltage range.

13. A resuscitation simulator as described in claim 12, wherein the signal pre-processing circuit comprises a first operational amplifier (UVB) which amplifies the measured signal from the receiver (7) and is connected to the first input of a second operational amplifier (UVC) functioning as a summer which subtracts a reference voltage (VCC_REF) from the amplified measurement signal.

14. A resuscitation simulator as described in claim 13, wherein the offset compensation circuit comprises a third operational amplifier (U2D) connected as a voltage follower and making an intermediate reference voltage (URef1) available at the output which is sent to a fourth, non-inverting operational amplifier (U2A) so that the fourth operational amplifier (U2A) amplifies the intermediate reference voltage (URef1) and the reference voltage (VCC_REF) and the output of the fourth operational amplifier (U2A) connected to the other input of the second operational amplifier (U2C), functioning as a summer.

15. A resuscitation simulator as described in claim 14, wherein the third operational amplifier (UVD) picks ff a partial voltage on a voltage divider (R3, R7), which is connected to the constant voltage source (AVCC).
